(19) United States
(12) Patent Application Publication
(10) Pub. No.: US 2007/0176153 A1
(43) Pub. Date: Aug. 2, 2007

(54) ELECTROMAGNETIC WAVE SHIELDING FILM, METHOD OF MANUFACTURING THE SAME, ELECTROMAGNETIC WAVE SHIELDING FILM FOR PLASMA DISPLAY PANEL, AND OPTICAL FILM

(75) Inventor: Hitoshi ADACHI, Tokyo (JP)

Correspondence Address: LUCAS & MERCANTI, LLP, 475 PARK AVENUE SOUTH, 15TH FLOOR, NEW YORK, NY, 10016, US

(73) Assignee: KONICA MINOLTA MEDICAL & GRAPHIC, INC., Tokyo (JP)

(21) Appl. No.: 11/624,793

(22) Filed: Jan. 19, 2007

(30) Foreign Application Priority Data
Jan. 31, 2006 (JP) JP2006-022236

(51) Int. Cl. H01B 1/22

(52) U.S. Cl. 252/512

(57) ABSTRACT

An object is to provide an electromagnetic wave shielding film and a method of manufacturing the same, exhibiting a high electromagnetic wave shielding property and high transparency at the same time, which is capable of easily forming a thin line pattern, and also exhibiting excellent sharpness together with excellent color tone. Another object is further to provide an electromagnetic wave shielding film and an optical film which are utilized for a plasma display panel by using an electromagnetic wave shielding film of the present invention. Disclosed are an electromagnetic wave shielding film possessing a metal portion and a light transparent portion, wherein the metal portion comprises a metal ion reducing agent, and an auxiliary agent by which reaction with a metal ion reducing agent is accelerated, and the method of manufacturing an electromagnetic wave shielding film thereof.

This application claims priority from Japanese Patent Application No. 2006-02236 filed on Jan. 31, 2006, which is incorporated hereinto by reference.

### TECHNICAL FIELD

The present invention relates to an electromagnetic wave shielding film exhibiting a high electromagnetic wave shielding property and high transparency at the same time, which is capable of easily forming a thin line pattern, and also exhibiting excellent sharpness together with excellent color tone, and to a method of manufacturing the electromagnetic wave shielding film.

### BACKGROUND

In recent years, the need of reducing Electro-Magnetic Interference (EMI) has heightened due to increasing usage of electronic devices. It has been pointed out that EMI causes malfunctions and failures of electronic and electrical devices, and is also hazardous to humans. For this reason, with respect to electronic devices, it is required that the strength of electromagnetic wave emission is controlled within the range of governmental standards or regulations.

Specifically, plasma display panel (PDP) generates electromagnetic waves in principle because it is based on the principle that rare gases are converted to a plasma state to emit ultraviolet rays stimulating phosphor to emit light. Further, since near-infrared rays are also emitted at this time, resulting in malfunction of operational devices, such as remote controls, so that near-infrared shielding capability as well as electromagnetic wave shielding capability has been desirable. Electromagnetic wave shielding capability is simply represented as a surface resistance value, and in the light-transmitting electromagnetic wave shielding material for a PDP, required is a value of less than 10 Ω/sq., and in a consumer plasma television using a PDP, the required value is less than 2 Q/sq., and the very high conductivity of less than 0.2 Ω/sq. is more desirable.

To solve the above problem, specifically to solve the problem of electromagnetic wave shielding, so far proposed has been a method of manufacturing an electromagnetic wave shielding material with a metal mesh having aperture portions such as an etching mesh with a photolithographic method (Patent Document 1) or an electrodeposition-processing mesh (Patent Document 2). However, these manufacturing processes are complicated, resulting in drawbacks caused by moiré or fattened intersecting points of metal lines.

In order to solve this problem, it is possible to prepare a metallic silver mesh via a manufacturing process with application of photographic development, since developed silver obtained from silver halide particles is metallic silver. For example, a conductive metal silver portion, in which silver particles are collected in the form of mesh, is formed when a light sensitive material having a layer containing silver halide particles is exposed mesh-shaped imagewise to light to conduct a development treatment (refer to Patent Document 3).

Though an electromagnetic wave shielding film exhibiting a high electromagnetic wave shielding property and high transparency at the same time is to be easily produced comparatively at low cost, performance particularly in sharpness and color tone of a thin line pattern, together with the high electromagnetic wave shielding property and high transparency is still insufficient and does not satisfy a high level demand of market.

(Patent Document 1) Japanese Patent O.P.I. Publication No. 2003-46293

(Patent Document 2) Japanese Patent O.P.I. Publication No. 11-26980

(Patent Document 3) Japanese Patent O.P.I. Publication No. 2004-221564

### SUMMARY

The present invention was made on the basis of the above-described situation. It is an object of the present invention to provide an electromagnetic wave shielding film and a method of manufacturing the same, exhibiting a high electromagnetic wave shielding property and high transparency at the same time, which is capable of easily forming a thin line pattern, and also exhibiting excellent sharpness together with excellent color tone. It is another object of the present invention to provide an electromagnetic wave shielding film and an optical film which are utilized for a plasma display panel by using an electromagnetic wave shielding film of the present invention. Disclosed is an electromagnetic wave shielding film comprising a metal portion and a light transparent portion, wherein the metal portion comprises a metal ion reducing agent, and an auxiliary agent by which reaction with the metal ion reducing agent is accelerated. Also disclosed is a method of manufacturing an electromagnetic wave shielding film comprising the steps of exposing to light a silver halide photographic sensitive material comprising a support and provided thereon, a light sensitive layer comprising light sensitive silver halide grains and an auxiliary agent by which reaction with a metal ion reducing agent is accelerated, and developing the silver halide photographic sensitive material, to form a metal portion and a light transparent portion.

### DESCRIPTION OF THE PREFERRED EMBODIMENTS

The above object of the present invention is accomplished by the following structures.

(Structure 1) An electromagnetic wave shielding film comprising a metal portion and a light transparent portion, wherein the metal portion comprises a metal ion reducing agent, and an auxiliary agent by which reaction with the metal ion reducing agent is accelerated.

(Structure 2) The electromagnetic wave shielding film of Structure 1, wherein the metal portion comprises the metal ion reducing agent, the auxiliary agent and a metal catalyst.

(Structure 3) The electromagnetic wave shielding film of Structure 1 or 2, wherein the auxiliary agent is a nitrogen-containing compound.

(Structure 4) The electromagnetic wave shielding film of any one of Structures 1-3, wherein the metal portion comprises silver, and the metal ion reducing agent is a silver ion reducing agent.

(Structure 5) The electromagnetic wave shielding film of any one of Structures 1-4, wherein the auxiliary agent is a hydrazine compound or a tetrazolium compound.

(Structure 6) A method of manufacturing an electromagnetic wave shielding film comprising the steps of exposing to light a silver halide photographic sensitive material comprising a support and provided thereon, a light sensitive layer comprising light sensitive silver halide grains and an auxiliary agent by which reaction with a metal ion reducing agent is accelerated, and developing the silver halide photographic sensitive material, to form a metal portion and a light transparent portion.

(Structure 7) The method of Structure 6, wherein the auxiliary agent is a hydrazine compound or a tetrazolium compound.

(Structure 8) The method of Structure 6 or 7, further comprising the step of conducting at least one of a heat treatment and an applied pressure treatment, after the development treatment.

(Structure 9) The method of any one of Structures 6-8, further comprising the step of conducting at least one of a physical development treatment and a plating process after the development treatment, to form a conductive metal portion in which conductive metal particles are carried to a metallic silver portion.

(Structure 10) The electromagnetic wave shielding film prepared via the method of any one of Structures 6-8.

(Structure 11) The electromagnetic wave shielding film of Structure 10, hDvinJ Dn DSHrturH rDtio of 85-99.9%, Dnd a surface resistance of 10⁻⁶-10² Ω/sq.

(Structure 12) An electromagnetic wave shielding film for a plasma display panel, comprising the electromagnetic wave shielding film of Structure 10 or 11.

(Structure 13) An optical film for a plasma display panel, comprising the electromagnetic wave shielding film of Structure 10 or 11.

(Structure 14) The optical film of Structure 13, comprising an anti-reflection layer, an adhesion layer, a hard coat layer and a near-infrared red absorption layer.

(Structure 15) The optical film of Structure 13 or 14, hDvinJ Dn DEsor Stion PDxiPuP in D wDvHOHnJth rHJion oI 560-620 nm.

While the preferred embodiments of the present invention have been described using specific terms, such description is for illustrative purposes only, and it is to be understood that changes and variations may be made without departing from the spirit or scope of the appended claims.

### DETAILED DESCRIPTION OF THE INVENTION

In the present invention, disclosed is an electromagnetic wave shielding film comprising a metal portion and a light transparent portion, wherein the metal portion comprises a metal ion reducing agent, and an auxiliary agent by which reaction with the metal ion reducing agent is accelerated. Also disclosed is a method of manufacturing an electromagnetic wave shielding film comprising the steps of exposing to light a silver halide photographic sensitive material comprising a support and provided thereon, a light sensitive layer comprising light sensitive silver halide grains and an auxiliary agent by which reaction with a metal ion reducing agent is accelerated, and developing the silver halide photographic sensitive material, to form a metal portion and a light transparent portion.

### (Silver Halide Photographic Light Sensitive Material)

In the present invention, a silver halide grain emulsion layer can contain silver halide grains, a binder, an activator and the like.

Silver halides preferably employed in this invention include ones which mainly contain AgCl, AgBr or AgI. To obtain a highly conductive metallic silver, it is preferable to employ microscopic silver halide grains exhibiting high sensitivity, after which preferably employed is AgBr-based silver halide grains containing iodine. Incidentally, when the iodine content is raised, it is possible to obtain microscopic silver halide grains exhibiting high sensitivity.

Silver halide grains are converted to metallic silver grains after development. Then, for electricity to flow from grain to grain, contact areas of the grains need to become as large as possible. For that purpose, it is best that grain size is reduced, but small grains easily aggregate into a large mass, and since contact areas decrease conversely, the optimal grain diameter results. As for an average grain size of a silver halide, it is preferably 1-1,000 nm (being 1 pP) in D sShHriFDO HTuivDOHnt diDPHtHr, P or H SrHIHrDEOy 1-100 nm, but still more preferably 1-50 nm. The spherical equivalent diameter of a silver halide grain means diameter of the sphere having an equivalent volume as the silver halide grain.

The shapes of silver halide grains are not specifically limited, and may be various shapes, such as spherical, cubic, tabular (hexagonal tabular, triangular tabular, square tabular), octahedral, or tetradecahedral shapes. In order to dramatically raise sensitivity, tabular grains exhibiting an aspect ratio of 2 or more, 4 or more, and further 8 or more and 16 or less, are preferably employed. The grain size distribution may be broad or narrow, but a narrower distribution is preferable to obtain high conductivity and a large aperture ratio. The degree of monodispersion as known in the photographic industry is preferably 100 or less, but more preferably 30 or less. From the viewpoint of enabling high electrical flow, the contact area among the formed grains is preferable as large as possible. Therefore, the shape of the grains is preferably tabular and exhibiting a large aspect ratio. However, since it is difficult to obtain high image density employing grains of a high aspect ratio, an optimum aspect ratio exists.

Silver halide employed in this invention may further contain other elements. For example, in a photographic emulsion, it is also useful to dope the metal ion to obtain a higher contrast emulsion. Specifically, transition metal ions, such as a rhodium ion, a ruthenium ion, and an iridium ion, are preferably employed, since it becomes easier to effect a difference of the exposed portions and the unexposed portions during formation of the metallic silver images. The transition metal ion represented by a rhodium ion and the iridium ion may also be a compound which has various ligands. As such a ligand, listed are a cyanide ion, a halogen ion, a thiocyanate ion, a nitrosyl ion, water, or a hydroxide ion. As an example of specific compounds, listed are potassium brominated rhodium acid, and potassium iridium acid.

In this invention, the content of the rhodium compound and/or iridium compound contained in a silver halide is preferably 10⁻¹⁰-10⁻² mol/molAg, but more preferably 10⁻⁹-10⁻³ mol/molAg, based on the molar number of silver in the silver halide.

In addition, in this invention, preferably employed may be a silver halide containing Pd ions, Pt ions, Pd metal, and/or Pt metal may also be employed. Pd or Pt may be uniformly distributed in silver halide grains, but it is preferable that Pd or Pt is contained near the surface layer of the grains.

In this invention, the content of Pd ion and/or Pd metal contained in the silver halide is preferably 10⁻⁶-0.1 mol/molAg based on the molar number of silver in the silver halide, and more preferably 0.01-0.3 mol/molAg.

Further, in this invention, the silver halide may be subjected to chemical sensitization to increase sensitivity as being conducted for a photographic emulsion. As chemical sensitization, for example, employed is noble metal sensitization, such as gold, palladium, or platinum sensitization; chalcogen sensitization, such as sulfur sensitization, selenium sensitization or tellurium sensitization using inorganic sulfur, an organic sulfur compound, an organic selenium compound or an organic tellurium compound; or reduction sensitization using tin chloride or hydrazine.

It is preferable that the chemically sensitized silver halide grains are further subjected to spectral sensitization. As preferable spectral sensitizing dyes, listed are cyanine, carbocyanine, dicarbocyanine, complex cyanine, hemicyanine, a styril dye, merocyanine, complex merocyanine, and a holopolar dye. These spectral sensitizing dyes, usually employed in the photographic industry, may be used singly or in combinations.

Specifically useful dyes are a cyanine dye, a merocyanine dye, and a complex merocyanine dye. In these dyes, any nucleus usually contained in a cyanine dye may serve to form a basic heterocyclic ring nucleus. Namely, those are a pyrroline nucleus, an oxazoline nucleus, a thiazoline nucleus, a pyrrole nucleus, an oxazole nucleus, a thiazole nucleus, a selenazole nucleus, an imidazole nucleus, a tetrazole nucleus, a pyridine nucleus, and nuclei which are formed by coalescence of these nuclei with alicyclic hydrocarbon rings; as well as nuclei which are formed by coalescence of those nuclei with aromatic hydrocarbon rings, that is, an indolenine nucleus, a benzindolenine nucleus, an indole nucleus, a benzoxazole nucleus, a naphthoxazole nucleus, a benzothiazole nucleus, a naphth thiazole nucleus, a benzselenazole nucleus, a benzimidazole nucleus, and a quinoline nucleus. These nuclei may be substituted on a carbon atom.

In a merocyanine dye or complex merocyanine dye, as a nucleus which features a ketomethylene structure, applicable are 5-6 membered heterocyclic ring nuclei, such as a SyrDzoOinH-5-onH nuFOHus, D thiohydDntoin nuFOHus, D 2-thio-oxazolidine-2, a 4-dion nucleus, a thiazolidine-2, a 4-dione nucleus, a rhodanine nucleus, and a thiobarbituric acid nucleus. Specifically preferable sensitizing dye is a near-infrared sensitizing dye. These dyes are based on Japanese Patent O.P.I. Publication Nos. 2000-347343, 2004-037711, and 2005-134710, preferable examples of which are shown below.

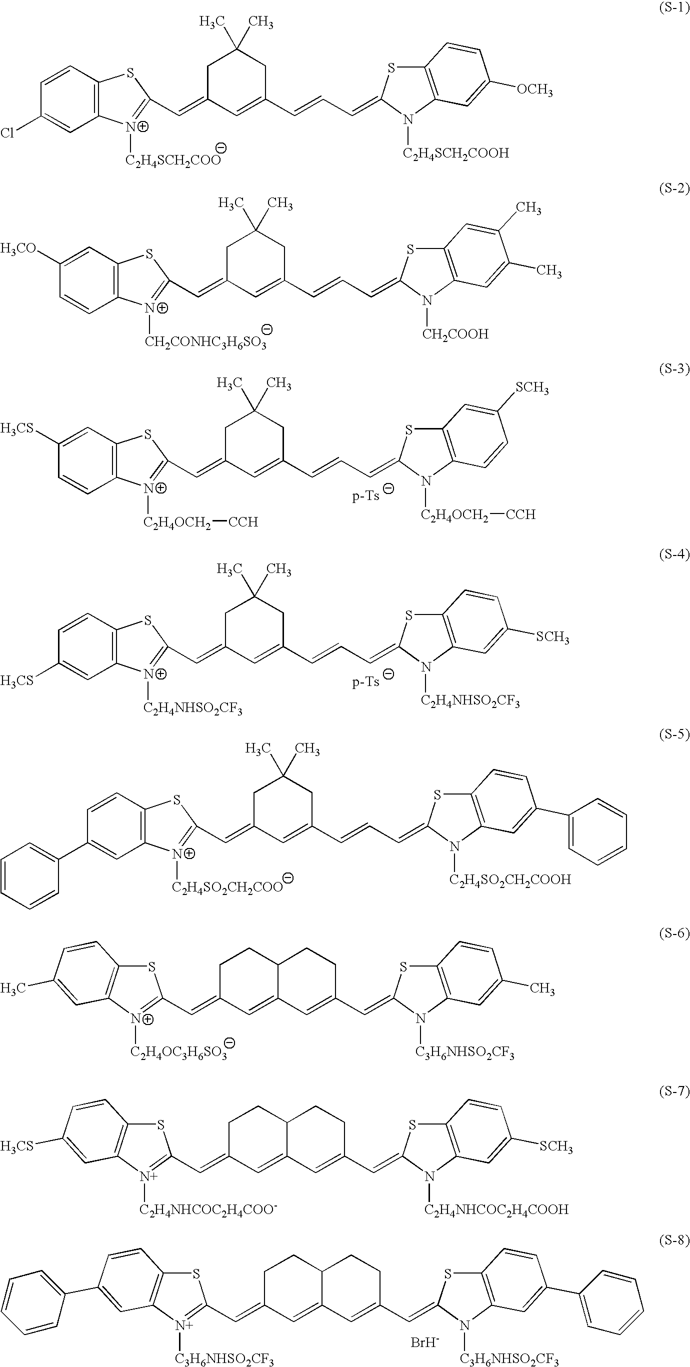

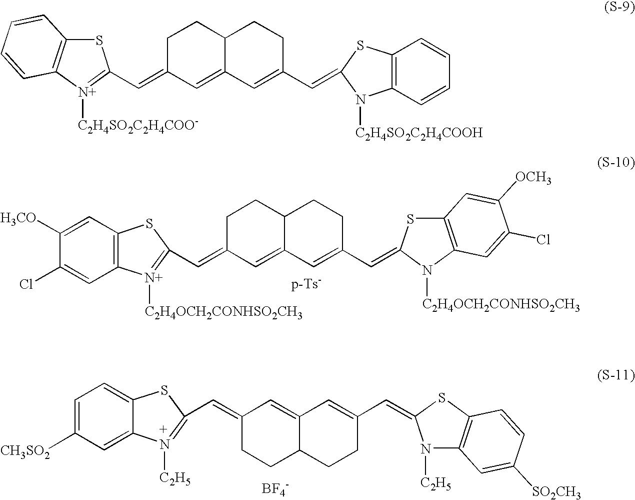

These sensitizing dyes may be employed alone or in combinations. Specifically, combinations of sensitizing dyes are often employed to achieve supersensitization.

To incorporate these sensitizing dyes in a silver halide emulsion, they may be directly dispersed in the emulsion, or may be added after being dissolved in a single or mixed solvent, such as water, methanol, propanol, methyl cellosolve, or 2, 2, 3, 3-tetra-fluoro propanol. Further, the dyes may be added as an aqueous solution under coexistence of an acid or a base, as described in Examined Japanese Patent Publication Nos. (hereinafter, referred to as JP-B) 44-23389, 44-27555, and 57-22089, or they may be added to the emulsion after having been dissolved as an aqueous solution or colloidal dispersion employing a surfactant, such as sodium dodecylbenzenesulfonate, as described in U.S. Pat. Nos. 3,822,135, and 4,006,025. Further, the dyes may be added to the emulsion, after having been dissolved in a basically water immiscible solvent, such as phenoxyethanol as well as being dispersed in water or a hydrophilic colloidal. Also, the dyes may be added to the emulsion as a dispersion in which the dyes are directly dispersed into a hydrophilic colloid, as described in Japanese Patent O.P.I. Publication Nos. 53-102733 and 58-105141.

In the silver halide grain containing layer of the present invention, a binder may be employed to uniformly disperse the silver halide grains and also to enhance adhesion between the silver halide grain containing layer and the support. In the present invention, either a non-water soluble polymer or a water soluble polymer may be employed as a binder, but preferable is a water-soluble polymer.

listed as a binder, for example, may be gelatin, polyvinyl alcohol (PsA) and its derivatives; polyvinyl pyrrolidone (PsP); polysaccharides, such as starch, cellulose and its derivatives; polyethylene oxide; polyvinyl amine; and polyacrylic acid. These compounds exhibit a neutral, anionic or cationic nature, by ionicity of the functional group.

The content of the binder contained in the silver halide grain containing layer of the present invention is not specifically limited, but may be determined in the range of exhibiting dispersibility and adhesion property, as suitable. The content of the binder in the silver halide grain FontDininJ ODyHr is SrHIHrDEOy 0.2-100 in thH wHiJht rdtio oI AJ/EindHr, is P or H SrHTHrDEOy 0.3-30, Dnd is stiOO P or H SrHTHrDEOy 0.5-15. ,n FDsHs whHn AJ is in For SorDtHd Dt 0.5 or more compared to the binder of the weight ratio in the silver halide grain containing layer, it is possible to attain higher electrical conductivity since metallic particles tend to contact each other more readily following heat-pressing treatment, which is preferable.

In the present invention, a plastic film, a plastic plate, or a glass plate may be employed as a support. Examples of raw materials of a plastic film and a plastic plate include, for example, polyesters, such as a polyethylene terephthalate (PET) and polyethylenenaphthalate (PEN); vinyl resin, such as polyethylene (PE), polypropylene (PP), and polystyrene; polycarbonate (PC); and triacetyl cellulose (TAC).

From the viewpoint of transparency, heat resistance, ease of handling, and cost, the above plastic film is preferably PET, PEN, or TAC.

In the electromagnetic wave shielding material for a display, high transparency is essential, so high transparency of the support is preferable. In this case, the total visible light transmittance of the plastic film or plastic plate is preferably at least 85%, more preferably at least 88%, and still more preferably at least 90%. Further, in the present invention, employed may be the above plastic film or the plastic plate colored with a tint adjusting agent, but must not impede the targeted objects of this invention.

Solvents employed for preparation of the coating solutions for the silver halide grain emulsion layer of this invention are not specifically limited, but cited may be water, organic solvents (for example, alcohols such as methanol and ethanol; ketones, such as acetone, methyl ethyl ketone, and methyl isobutyl ketone; amides, such as formamide; sulfoxide, such as dimethyl sulfoxide; esters, such as ethyl acetate; and ethers), ionic liquids, and mixed solvents of these.

The content of the solvent employed in the silver halide grain emulsion layer of this invention is preferably in the range of 30-90% by weight compared to the total weight of the silver halide grains along with the binder contained in the above silver containing layer, and is more preferably in the range of 40-80% by weight.

### (Exposure)

In this invention, exposure is conducted on the silver halide grain emulsion layer applied on the support. Exposure may be performed employing electromagnetic waves. Listed as electromagnetic waves are, for example, light, such as visible light and rs lights; and radioactive rays, such as electronic beams, and u-rays, but rs light or near-infrared rays are preferable. Further, a light source which has an appropriate wavelength distribution may be employed for light exposure, however a light source of a narrow wavelength distribution may also be employed for light exposure.

To obtain visible light, employed may be various luminous bodies exhibiting photogenesis in the appropriate spectral regions. For example, employed may be any one of a red luminous body, a green luminous body, or a blue luminous body, or a mixture of at least two of them. The spectral regions are not limited to the above red, green and blue, and also employed may be luminous bodies of yellow, orange or violet, or a fluorescent material producing luminescence in the infrared region. Further, an ultraviolet lamp is also preferable, and g-beams or I-beams of a mercury lamp may also be employed.

Further, in this invention, exposure may be conducted with employment of various laser beams. For example, exposure of this invention is preferably conducted employing a scanning exposure method with a monochromatic high-density beam using a gas laser, a light-emitting diode, a semiconductor laser, a second harmonic generation (SHd) light source combined a nonlinear optical crystal and a semiconductor laser, or a solid-state laser which employs a semiconductor laser as an excitation light source. Further, a hrF excimer laser, an ArF excimer laser, and an F2 laser may also be employed. To keep the system compact and high efficiency, exposure is preferably conducted employing a semiconductor laser, or a second harmonic generation light source (SHd) combined a semiconductor laser or a solid-state laser, and a nonlinear optical crystal. Specifically, to design a compact device featuring high efficiency, longer-life and being highly stable, exposure is preferably conducted employing a semiconductor laser.

Specifically, as a laser light source, preferably cited are an ultraviolet semiconductor laser, a blue semiconductor laser, a green semiconductor laser, a red semiconductor laser, and a near-infrared laser.

An image exposure method on a silver halide grain containing layer may be employed with plane exposure using a photomask, or scanning exposure using laser beams. In this case, exposure may be via a condenser type exposure employing a lens or a reflector type exposure employing a reflecting mirror, and employed may be an exposure method of face-to-face contacting exposure, near-field exposure, reduction-projection exposure, or reflective projection exposure. Since output power from a laser is required to be of a suitable quantity to expose the silver halide, it is DFFHStDEOH Dt D OHvHO of sHvHrDO uW 5 W.

### (Development Treatment)

In the present invention, after a silver halide grain emulsion layer is exposed to light, a metallic silver (for a latent image formed via exposure) is employed as a catalyst to conduct a development treatment. The usual development treatment technique employed for silver halide grain photographic film, printing paper and graphic arts printing film, as well as an emulsion mask for photomasking, may be employed. The developing solution is not particularly limited, but a Pn developing solution, an Mn developing solution, an MAA developing solution and so forth are preferably usable. In this invention, metallic silver portions, preferably being image producing metallic silver portions, are formed together with light transparent portions, described later, by conducting the above exposure and development treatment.

The development treatment in this invention may include fixing process performed in order to remove the silver halide grains in the unexposed portions and stabilize those kinds of grains in the exposed areas. In the fixing process of this invention, the fixing process technique employed for silver halide grain photographic film, printing paper and graphic arts printing film, as well as an emulsion mask for photomasking, are preferred.

The developing solution composition employed for this invention may include hydroquinones as a developing agent, that is to say, a silver ion reducing agent, such as hydroquinone, sodium hydroquinone sulfonate, and chlorohydroquinone, and together in combination with these, employed may be a superadditive developing agent, such as pyrazolidones, e.g., 1-phenyl-3-pyrazolidone, 1-phenyl-4,4-dimethyl-3-pyrazolidone, 1-phenyl-4-methyl-4-hydroxymethyl-3-pyrazolidone, and 1-phenyl-4-methyl-3-pyrazolidone; and N-methyl-p-aminophenol sulfate. Further, it is preferable to employ reductone compounds, such as ascorbic acid and D-iso-ascorbic acid, without using hydroquinone.

A sodium sulfite salt or a potassium sulfite salt may be incorporated as a preserving agent, and a sodium carbonate salt or a potassium carbonate salt may be incorporated as a buffering agent, and diethanolamine, or triethanolamine, and diethylamino propanediol may be incorporated as a development accelerator.

The developing solution pH may be adjusted to the range of 9-12 with an alkaline chemical, such as sodium hydroxide or potassium hydroxide. The pH may generally be set in the range of 10-0.5 for storage stability, but it may also be set in the range of 11-0.5 for a rapid processing. Development treatment may be conducted under the conditions of 20-40° C., for 1-90 seconds. Further, the replenishing rate of the developing solutions or fixing solutions may be sHt to thH rDnJH oI 5-216 PO SHr P², or less than this when using a development accelerator or a sensitizer. As for reduction of the replenishing rate, it is specifically effective that the amount of silver halide grains is reduced based on the sensitization technique of the emulsion, and reduction of the replenishing rate is achieved by reduction of silver halide grains together with the above developing acceleration technique.

The developing solution employed in development treatment may incorporate a quality improving agent for the purpose to raise image quality. As such a picture quality improving agent, cited for example, is a nitrogen containing heterocyclic compound, such as 1-phenyl-5-mercaptotetrazole and 5-methylbenzotriazole.

Image contrast, after development treatment in this invention, is not specifically limited, but it preferably exceeds 4.0. If the contrast after development treatment exceeds 3.0, the electrical conductivity in the conductive metal portion may be increased to maintain higher transparency in the light transparent portion. As a method to maintain a contrast of 3.0 or more, cited is, for example, doping of the foregoing rhodium or iridium ions.

A fixing solution may be incorporated in this invention such as sodium thiosulfate, potassium thiosulfate, or ammonium thiosulfate as a fixing agent. Aluminium sulfate, or chromium sulfate may be employed as a hardening agent at the time of fixing. As a preserving agent of the fixing agent, employed may be sodium sulfite, potassium sulfite, ascorbic acid, and erythorbic acid, which are described in the developing composition, while in addition, citric acid, or oxalic acid may also be employed.

Employed may be as an antifungal agent in the washing water used in the present invention, N-methyl-isothiazole-3-one, N-methyl-isothiazole-5-chloro-3-one, N-methyl-isothiazole-4,5-dichloro-3-one, 2-nitroglycerine-2-bromine-3-hydroxypropanol, 2-methyl-4-chlorophenol, or hydrogen peroxide.

Next, the conductive metal portion of this invention will be described.

In the present invention, the conductive metallic portions are formed by conducting an applied pressure treatment to metallic silver portions formed via the foregoing exposure and development treatment, and subsequently carrying the conductive metal particles to the foregoing metallic silver portions. In this case, conductivity is increased since metal particles or metal filaments contained in the conductive metal portion are closely connected in contact with each other via at least one of a heat treatment and an applied pressure treatment.

Pressing onto the electromagnetic wave shielding material of this invention is performed by face-to-face pressing in which pressure is applied onto the material laying on a plate, nip-roller pressing in which pressure is applied to the material while it passes between rollers, or a combined pressing process of these. The amount of pressure is appropriately chosen within 1 kPa-100 MPa, preferably 10 N3D-1003D, Eut P or H SrHIHrDEOy 50 N3D-5 03D. ,n FDsHs when pressing is less than 1 kPa, the effect of sufficient contact onto each particle cannot be assured, and when it is more than 100 MPa, it is difficult to maintain a flat surface of the material, resulting in undesirably increased haze.

Further, heating during pressurization may be EHnHIiFiDO, Dnd is SrHIHrDEOy in thH rDnJH oI 40-300° C. The duration of heating depends on the temperature, being a short time at high temperature, while longer at a lower one.

As a heating method, in the case of nip-roller type, one is heating rollers to a predetermined temperature while another method is to heat the material in a heating section, such as an autoclave chamber. It is preferable to laminate plural sheets of a predetermined size and to simultaneously heat them, to realize high productivity. To enhance the efficiency of the heat treatment, it is preferable to employ thermoplastic materials alone or combinations of them as a binder. It is also preferable to employ a combination of polymers exhibiting a glass transition point of less than 40° C. As such polymers, employable are a single homopolymer, or a multicomponent copolymer containing more than two components. Further, it is possible to employ a natural wax, such as Carnauba wax, an artificial wax such as a chain-extended wax, or rosins.

Further, it is allowable to employ laser heating as a heating method. The kind of laser light may be appropriately chosen based on the silver coverage, to the radiating laser beam and the adhesive agent. For example, listed as a laser light are such as a neodymium laser, a vAd laser, a ruby laser, a herium-neon laser, a krypton laser, an argon laser, an H₂ laser, a N₂ laser, and a semiconductor laser. As more preferable lasers, cited are a vAdWneodymium³⁺ laser (at a laser wavelength of 1,060 nm) and a semiconductor laser (at a ODsHr wDvHOHnJth oI 500-1,000 noP). 7hH ODsHr EHDP outSut is SrHIHrDEOy 5-1,000 W. 7hH ODsHr EHDP PDy EH D continuous wavelength or a wave pulse type. If the width of a pulse wave is controlled, adjustment of heating is possible and is therefore easy to determine optimal conditions. In cases when the laser output exceeds 1,000 t, it is not desirable because ablation is generated and volatilization•evaporation tends to occur.

In cases when a near-infrared absorption dye is employed in a preferable embodiment of this invention, it is desirable to employ an infrared semiconductor laser in the rDnJH oI 800-1,000 nP.

In the application of a light-transmitting electromagnetic wave shielding material, the line width of the above conductive metal portion is preferably 20 μm or less, and a line space of it is preferably 50 μm or more. Further, the conductive metal portion may have a part in which the line width is more than 20 μm for a ground connection. Further, from the viewpoint of not to through images into relief, it is preferable that the line width of the conductive metal portion is less than 18 μm, more preferably less than 15 μm, and still more preferably less than 14 μm, further still more preferably less than 10 μm, and most preferably less than 7 μm.

It is preferable that an electromagnetic wave shielding TIOP oT thH SrHsHnt invention hDs Dn DSHrturH rDtio oI 85-99.9%, and also has a surface resistance of 10⁻⁶-10² Ω/sq. That is, the conductive metal portion of the present invention preferably has an aperture ratio of at least 85% in view of visible light transmittance, more preferably has an aperture ratio of at least 90%, and has most preferably has Dn DSHrturH rDtio oI Dt OHDst 95%. “ASHrturH rdtio” PHDns the ratio of non-line areas where no thin lines form a mesh, compared to the total area of a mesh, and, for example, the aperture ratio of a square, lattice type of mesh of a line width of 10 μm and a pitch of 200 μm is 90%.

“/iJht trDnsSDrHnt Sortion” in this invention PHDns that portion, which exhibits transparency, other than the conductive metallic portions in the transparent electromagnetic wave shielding film (shielding material). The average visible light transmittance in the light transparent portion is at least 90% which is shown at the DvHrDJH trDnsPittDnFH vDOuH in thH wDvHOHnJth rHJion oI 400-750 nm, except for the light absorption and reflective contribution of the support, is preferably at least 95%, more preferably at least 97%, still more preferably at least 98%, and most preferably at least 99%.

The thickness of the support of the transparent electromagnetic wave shielding material in this invention is SrHIHrDEOy 5-200 pP, Eut P or H SrHTHrDEOy 30-150 pP. ,I the support is in the range of 5-200 μm, the targeted visible light transmittance is easily attained, and handling of it is also easy.

The appropriate thickness of the metallic silver portions applied onto the support may be measured based on the coating thickness of the coating material for the silver halide grain containing layer applied onto the support. The thickness of the metallic silver portions is preferably at most 30 μm, more preferably at most 20 μm, still more preferably 0.01-9 μm, but is most preferably 0.05-5 μm.

The thickness of the conductive metal portion is preferably desired as thin as possible whereby it is viewable at wider angles on a display for use as an electromagnetic wave shielding material of a display. Further, for use as a conductive wiring material, it is required to be still thinner due to the desirability of being dens. From this viewpoint, the thickness of the layer comprising electrical conductive metals dispersed in the conductive metallic portion is preferably thinner than 9 μm, more preferably from at least 0.1 μm to thinner than 5 μm, and still more preferably from at least 0.1 μm to thinner than 3 μm.

In this invention, a functional layer may be separately provided, if of benefit. This functional layer may be of various specifications for each application. For example, for an electromagnetic wave shielding material application for a display, provided may be an anti-reflection layer which functions by adjusting the refractive index and coating thickness; a non-glare coating or an anti-glare coating, both of which exhibit a glare decreasing function; a layer for an image color adjustment function, which absorbs visible light of a specific wavelength; an antifouling layer which functions to easily remove dirt, such as a finger-prints; a scratch-resistant hard coating layer; a layer which serves an impact-absorbing function; and a layer which functions to prevent glass scattering in case of glass breakage. These functional layers may be applied onto the support of the reverse of a silver halide grain containing layer, and may be further applied onto the same side.

These functional films may be adhered directly onto the PDP, but may also be adhered onto a transparent base material, such as a glass plate or a plastic plate, separate from the body of a plasma display panel. The functional film may be called an optical filter (or simply a filter).

To minimize reflection of outside light for maximum contrast, an anti-reflection layer having an anti-reflection function may be prepared by a single-layer or a multi-layer laminating method of a vacuum deposition method, a sputtering method, an ion plating method, or an ion beam assist method, in which an inorganic material, such as a metal oxide, a fluoride, a silicide, a boride, a carbide, a nitride, or a sulfide is laminated; or by a single-layer or a multi-layer laminating method, in which employed may be resins exhibiting different refractive indices. Further, a film provided with an antireflection treatment may be adhered onto the filter. Further, a film with a non-glare or an anti-glare treatment may be adhered onto the filter. Further, a hard-coat layer may further be adhered, if of benefit.

The layer with an image color adjustment function, which absorbs visible light of a specific wavelength, is one to correct the emitted light color, and to contain dye absorbing light near 595 nm, because the PDP exhibits a drawback to display a bluish color as a purplish blue, due to the characteristics of the blue emitting fluorescent material which emits a slightly red light. Specific examples of the dyes absorbing the specified wavelengths include well-known inorganic dyes, organic pigments, and inorganic pigments, such as an azo dye, a condensed azo dye, a phthalocyanine dye, an anthlaruinone dye, an indigo dye, a perylene dye, a dioxadine dye, a quinacridone dye, a methane dye, an isoindolinone dye, a quinophthalone dye, a pyrrole dye, a thioindigo dye, and a metal complex dye. Of these, preferred are the phthalocyanine and anthraquinone dyes, due to their excellent weather resistance.

### (Contrast-Increasing Agent)

In the present invention, disclosed is an electromagnetic wave shielding film comprising a metal portion and a light transparent portion, wherein the metal portion comprises a metal ion reducing agent, an auxiliary agent by which reaction with the metal ion reducing agent is accelerated, and a metal catalyst. In the present invention, commonly known contrast-increasing agents or various compounds called the nucleating agent are usable in the field of photographic technique as the auxiliary agent by which reaction with a metal ion reducing agent is accelerated. Of these compounds, a hydrazine compound, a tetrazolium compound and the like are preferable.

As to a silver halide photographic light sensitive material, a hydrazine compound or a tetrazolium compound (referred to also as T compound) as a contrast-increasing agent is contained in a silver halide particle having a silver chloride content of at least 60 mol %. Further, an amine compound is also usable as a contrast-increasing auxiliary agent.

A hydrazine compound is a compound having an —NHNH— group, typical examples can be expressed by following formula xHz.

t-NHNHCHO or t-NHNHCOCO-v Formula xHz

In the above formulas, t and v are an alkyl group which may be substituted, an aryl group which may be substituted, or a hetero ring group which may be substituted, and v is also an amino group which may be substituted. The aryl group represented by t and v contains a benzene or naphthalene ring, and the hetero ring group contains a pyridine ring or a quinoline ring. The aryl group may be substituted by various substituents, and preferable examples of the substituents include a straight or blanched alkyl group (being preferably a methyl group, an ethyl group, an isopropyl group, or an N-dodHFyO JrouS, hDvinJ 2-20 FDrEon DtoPs); Dn DONoxy JrouS (being preferably a methoxy group, or an ethoxy group, having 2-21 FDrEon DtoPs); Dn DOiShDtiF DFyODPino JrouS (EHinJ preferably an acetylamino group, or a heptylamino group, hDvinJ Dn DONyO JrouS oI 2-21 FDrEon DtoPs); Dnd Dn aromatic acylamino group. In addition to these groups, are for example, groups in which the above substituted or unsubstituted aromatic rings are linked with a linkage group, such as —CONH—, —O—, —SO₂NH—, —NHCONH—, or —CH₂CH₂N—. Further, v is preferably an amino group, and a compound having a piperidyl-4-amino group as a moiety is preferable.

These hydrazine compounds may be synthesized based on a method described in U.S. Pat. No. 4,269,929.

Hydrazine compounds may be incorporated into the emulsion layer, an hydrophilic colloid layer adjacent to the emulsion layer, or other hydrophilic colloid layers. As an addition method, hydrazine compounds can be added after dissolving them in alcohols such as methanol, ethanol and the like, ethylene glycols, ethers or ketones. The addition amount may be 10⁻⁶-10⁻¹ mol per one mol of silver halide, and preferably 10⁻⁴-10⁻² mol.

Specific hydrazine compounds preferably usable in the present invention are listed below.
(a)W 1-formyl-2-{x4-(3-n-butylureido)phenylz}hydrazine
(b)W 1-formyl-2-{4-x2-(2,4-di-tert-pentylphenoxy)butylamidezphenyl}hydrazine
(c)W 1-(2,6-tetramethylpiperidinooxazarylamide)-2-{4-x2-(2,4-di-tertpentylphenoxy)butylamidezpheny}hydrazine
(d)W 1-(2,6-tetramethylpiperidinooxazarylamide)-2-{4-x2-(2,4-di-tert-pentyiphenoxy)butylamidezphenylsulfonamidephenyl}hydrazine
(e)W 1-(2,6-tetramethylpiperidinooxazarylamide)-2-{3-(1-ShHnyO-1′-S-FhOoroShHnyOPHthDnHthioJOyFinHDPidHShHny) sulfonamidephenyl}hydrazine
(f)W 1-formyl-2-{x4-(octyl-tetraethyleneoxide-thio-glycineamidephenyl)-methylpiperidyl-4 amino-oxalylz-2-x4 (3-thia-6,9,12,15-tetraoxatricosaneamide) sulfonamidephenylz}hydrazine

Of these above-exemplified compounds, an amino group type in which v in the foregoing formula is substituted, as shown in (a), (b) and (c) is particularly preferable.

Next, a tetrazolium compound as the contrast-increasing agent usable in the present invention is represented by following formula.

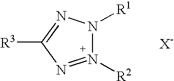

In the above formula, o¹, o² and o³ are an alkyl group which may be substituted, an aryl group which may be substituted, and a hetero ring group which may be substituted, respectively. As the preferable substituent, thH DONyO JrouS hDs 1-16 FDrEon DtoPs, Dnd thH DONoxy group, hydroxyalkyl group, cyano group, amino group, hydroxy JrouS, hDOoJHn DtoP Dnd nitro JrouS HDFH hDvH 1-8 FDrEon atoms. u⁻ represents an anion, and examples of the anionic group include a halogen atom, and an alkylsulfonate group, an alkylbenzenesulfonate group, an alkylcarboxylic acid group or an alkylbenzenecarboxylic acid group containing a substituted or unsuEstitutHd DONyO JrouS hDvinJ 1-24 FDrEon DtoPs.

Tetrazolium salts usable in the present invention are shown below.
(1)W 2,3-di(p-methoxyphenyl)-5-phenyltetrazolium chloride
(2)W 2,3-di(p-methylphenyl)-5-phenyltetrazolium chloride
(3)W 2,3-di(o-methylphenyl)-5-phenyltetrazolium chloride
(4)W 2,3,5-tri(P-methylphenyl) tetrazolium chloride
(5)W 2,3-di(p-methoxyphenyl)-5-(p-ethoxyphenyl) tetrazolium chloride
(6)W 2,3-di(p-methylphenyl)-5-(p-ethoxyphenyl) tetrazolium chloride
(7)W 2,3-di(p-hydroxyphenyl)-5-(p-cyanoethylphenyl) tetrazolium chloride
(8)W 2,3,5-tri(p-methoxyphenyl) tetrazolium chloride
(9)W 2,3,5-tri(m-methylphenyl) tetrazolium chloride

In the present invention, tetrazolium compounds described in Japanese Patent Examined Publication No. 5-58175 are usable in addition to the above-described compounds.

An amine compound may be contained in a silver halide photographic light sensitive material as a contrast-increasing agent. The amine compound may be represented by the following formula containing at least one nitrogen atom.

o-N(w)-n or o-N(w)-i-N(t)-n

In the above formula, o, n, w and t represent a suEstitutHd or unsuEstitutHd DONyO JrouS hDvinJ 2-30 FDrEon atoms, the alkyl group may be combined with a heteroatom such as nitrogen, sulfur or oxygen. o and w, or n and t may form a saturated or unsaturated ring to each other. i represents a divalent bridging group, a heteroatom such as sulfur, oxygen or nitrogen may be combined in the bridging group. % ridJinJ JrouS/is FDSDEOH oI hDvinJ 1-200 FDrEon DtoPs, 1-30 suOIur DtoPs, 1-20 nitroJHn DtoPs, Dnd 1-40 oxyJHn atoms, but it is not limited thereto.

These amine compounds are specifically exemplified below, but these compounds are not limited thereto.

Examples of the amine compounds include diethylamino ethanol, dimethylamino-1,2-propanediol, 5-amino-1-pentanol, diethylamine, methylamine, triethylamine, dipropylamine, 3-dimethylamino-1-propanol, 1-dimethylamino-2-propanol, bis (dimethylaminotetraethoxy) thioether, bis (diethylaminopentaethoxy) thioether, bis (piperidinotetraethoxy) thioether, bis (piperidinoethoxyethyl) thioether, bis (dicyanoethylaminodiethoxy) ether, bis (diethoxyethylaminotetraethoxy) ether, 5-dibutylaminoethylcarbamoyl benzotriazole, 5-morpholinoethylcarbamoyl benzotriazole, 5-(2-methylimidazole-2-ethylene) carbamoyl benzotriazole, 5-dimethylaminoethylureylene benzotriazole, 5-diethylaminoethylureylene benzotriazole, 1-diethylamino-2-(6-aminopurine) ethane, 1-(dimethylaminoethyl)-5-mercaptotetrazole, 1-piperidinoethyl-5-mercaptotetrazole, 1-dimethylamino-5-mercaptotetrazole, 2-mercapto-5-dimethylaminoethylthio thiadiazole, and 1-mercapto-2-morpholinoethane.

To use these amine compounds, appropriately selected can be compounds described in Japanese Patent O.P.I. Publication Nos. 57-120434, 57-129435, 57-129436, 60-129746, 56-94347, 60-140340, 60-218642 or 60-66248, and U.S. Pat. No. 3,021,215, 3,046,134, 3,523,787, 3,746,545, 4,013,471, 4,038,075, 4,072,523 or 4,072,526.

### (Near-Infrared Absorption Layer)

then an electromagnetic wave shielding film of the present invention is used as a plasma display optical film, malfunction of electronic devices caused by infrared rays can be prevented by directly coating a near-infrared absorption layer containing a near-infrared absorption agent on the same side of an electromagnetic wave shielding film or on the side opposite the electromagnetic wave shielding film, or by attaching a sheet having the near-infrared absorption layer provided on another support onto an electromagnetic wave shielding film of the present invention via an adhesive.

As specific examples of near-infrared absorption agents, listed are compounds of a polymethine system, a phthalocyanine system, a naphthalocyanine system, a metal complex system, an aminium system, an imonium system, a diimonium system, an anthraquinone system, a dithiol metal complex system, a naphthoquinone system, an indophenol system, an azo system, and a triarylmethane system.

In an optical filter for PDP, requirement of capability of near-infrared absorption is mainly due to heat ray absorption and noise prevention of electronic devices. Therefore, preferred are dyes which exhibit near-infrared absorption capability and a maximum absorption wavelength of 750-1100 noP, Dnd sSHFiTIFDOOy SrHIHrDEOH DrH FoPSounds oT D metal complex system, an aminium system, a phthalocyanine system, a naphthalocyanine system, and a diimonium system.

The absorption maximum of the conventionally known nickel dithiol complex system compound or a fluorinated ShthDOoFyDninH systHP FoPSound is 700-900 nP, Dnd Sut into practical use, usually, an effective near-infrared absorption effect can be obtained by employing them in combination with the aminium system compound, especially a diimonium system compound exhibiting the absorption maximum in a longer wavelength region than the above compound. (Please also refer to Japanese Patent O.P.I. Publication Nos. 10-283939, 11-73115, and 11-231106.) In addition, bis(1-thio-2-phenolate) nickel-tetrabutyl onium salt complex of Japanese Patent O.P.I. Publication No. 9-230931, bis(1-thio-2-naphthlate) nickel-tetrabutyl ammonium salt complex of Japanese Patent O.P.I. Publication No. 10-307540 may be cited.

Examples of specific compounds of diimonium system compounds are shown below.
(,5-1): 1,1,1′,1′-tHtrDNis(4-di-n-EutyODPinoShHnyO)-1,4-benzoquinone-bis(imonium•hexafluoroantimonic acid),
(,5-2): 1,1,1′,1′-tHtrDNis(4-di-n-EutyODPinoShHnyO)-1,4-benzoquinone-bis(imonium•perchloric acid),
(,5-3): 1,1,1′,1′-tHtrDNis(4-di-DPyODPinoShHnyO)-1,4-benzoquinone-bis(imonium•hexafluoroantimonic acid),
(,5-4): 1,1,1′,1′-tHtrDNis(4-di-n-SroSyODPinoShHnyO)-1,4-benzoquinone-bis(imonium•hexafluoroantimonic acid),
(,5-5): 1,1,1′,1′-tHtrDNis(4-di-n-hHxyODPinoShHnyO)-1,4-benzoquinone-bis(imonium•hexafluoroantimonic acid),
(,5-6): 1,1,1′,1′-tHtrDNis(4-di-iso-SroSyODPinoShHnyO)-1,4-benzoquinone-bis(imonium•hexafluoroantimonic acid),
(,5-7): 1,1,1′,1′-tHtrDNis(4-di-n-SHntyODPinoShHnyO)-1,4-benzoquinone-bis(imonium•hexafluoroantimonic acid),
(,5-8): 1,1,1′,1′-tHtrDNis(4-di-PHthyODPinoShHnyO)-1,4-benzoquinone-bis(imonium•hexafluoroantimonic acid),

In addition, when a dye exhibiting near-infrared absorption capability is incorporated in an image tone correction layer, any one of the above dyes may be incorporated alone, but two or more kinds may also be incorporated. To avoid aging deterioration of the near-infrared absorption dye, it is preferable to employ an ultraviolet absorption dye.

As a rs absorbing agent, a well-known rs absorbing agent, for example, a salicylic acid system compound, a benzophenone system compound, a benzotriazole system compound, an S-triazine system compound, or a cyclic imino ester system compound may be employed preferably. Of these, preferable are a benzophenone system compound, a benzotriazole system compound, and a cyclic imino ester system compound. As to what is blended into the polyester, specifically preferable is a cyclic imino ester system compound.

Specifically, preferable examples thereof includes
(rs-1)W 2-(2-hydroxy-3,5-di-α-cumyl)-2H-benzotriazole
(rs-2)W 5-chloro-2-(2-hydroxy-3-tert-butyl-5-methylphenyl)-2H-benzotriazole
(rs-3)W 5-chloro-2-(2-hydroxy-3,5-di-tert-butylphenyl)-2H-benzotriazole
(rs-4)W 5-chloro-2-(2-hydroxy-3,5-di-α-cumylphenyl)-2H-benzotriazole
(rs-5)W 5-chloro-2-(2-hydroxy-3-α-cumyl-5-tert-octylphenyl)-2H-benzotriazole
(rs-6)W 2-x3-tert-butyl-2-hydroxy-5-(2-isooctyloxycarbonylethyl)phenylz-5-chloro-2H-benzotriazole
(rs-7)W 5-trifluoromethyl-2-(2-hydroxy-3-α-cumyl-5-tert-octylphenyl)-2H-benzotriazole
(rs-8)W 5-trifluoromethyl-2-(2-hydroxy-5-tert-octylphenyl)-2H-benzotriazole
(rs-9)W 5-trifluoromethyl-2-(2-hydroxy-3,5-di-tert-octylphenyl)-2H-benzotriazole
(rs-10)W 3-methyl(5-trifluoromethyl-2H-benzotriazole-2-yl)-5-tert-butyl-4-hydroxyhydrocinnamate
(rs-11)W 5-butylsulfonyl-2-(2-hydroxy-3-α-cumyl-5-tert-octylphenyl)-2H-benzotriazole
(rs-12)W 5-trifluoromethyl-2-(2-hydroxy-3-α-cumyl-5-tert-butylphenyl)-2H-benzotriazole
(rs-13)W 2,4-bis(4-biphenylyl)-6-(2-hydroxy-4-octyloxycarbonylethylideneoxyphenyl)-s-triazine
(rs-14)W 2,4-bis(2,4-dimethylphenyl)-6-x2-hydroxy-4-(3-nonyloxy*-2-hydroxypropyloxy)-5-α-cumylphenylz-s-triazine (*W mixture of an octyloxy group, a nonyloxy group and a decyloxy group)
(rs-15)W 2,4,6-tris(2-hydroxy-4-isooctyloxycarbonylisopropylideneoxypnenyl)-s-triazine
(rs-16)W hydroxyphenyl-2H-benzotriazole
(rs-17)W 2-(2-hydroxy-5-methylphenyl)-2H-benzotriazole
(rs-18)W 2-(3,5-di-tert-butyl-2-hydroxyphenyl)-2H-benzotriazole

The above dyes are preferably fixed in the dye layer as 0.01-10 up PiFro-SDrtiFOHs HPSOoyinJ Dn DtoPizinJ PDFhinH, to be mentioned later, and the added amount is one which preferably attain an optical density in the range of 0.05-3.0 at the maximum wavelength.

### (Physical Development Treatment and Plating Treatment)

In the present invention, in order to provide conductivity to the metallic silver portion formed by the aforementioned exposure and development, at least one of a physical development treatment and a plating process is performed to carry conductive metal particles to the aforementioned metallic silver portion. In the present invention, only the physical development or plating process ensures that the conductive metal particles are carried by the metallic portion. A combination of physical development and plating process ensures that conductive metal particles are carried by the metallic silver portion.

“Physical development treatment” in the present invention signifies that the metal ion such as silver ion in a soluble metal salt-containing solution is deposited on the nucleus of the metal and metallic compound through reduction by the reducing agent. This physical development treatment is utilized for instant B C t film, instant slide film, and printing and prepressing. This technology is usable in the present invention. The Physical development treatment can also be performed simultaneously with a development treatment subsequent to exposure, or separately subsequent to a development treatment.

In the present invention, the process of plating can be performed according to the electroless plating method (chemical reduction plating and substitution plating), the electrolytic plating method, or a combination of both methods. The commonly known electroless plating technology can be used to perform electroless plating in the present invention. For example, it is possible to use the electroless plating technology practiced in the field of a printed circuit board. The electroless copper plating method is preferably used as electroless plating.

The chemical species contained in the electroless copper plating solution is exemplified by copper sulfide and copper chloride, the reducing agent by formalin and glyoxyl acid, and the copper ligand by EDTA and triethanol amine. Further, the additive for improving the stabilization of the bath and the smoothness of the plating membrane is exemplified by polyethylene glycol, yellow prussiate of potash and bipyridine. The electrolytic copper plating bath is exemplified by copper sulfate bath and copper pyrophosphate bath.

The process of plating in the present invention can be performed at a slow rate. It is also possible to make the process of plating at high rate of 5 μm/hour or over. In the process of plating, various types of additives such as a ligand exemplified by EDTA can be used to increase the stabilization of the plating solution.

### (Oxidation Treatment)

In the present invention, the metallic silver portion subsequent to development, and the conductive metallic section formed subsequent to physical development and/or plating are preferably subjected to oxidation treatment. Oxidation treatment removes this metal, for example, when a slight amount of metal is deposited on the optically transparent section, with the result that the transmittance of the optically transparent section is kept almost 100%.

The oxidation treatment is provided by the commonly known method using various types of oxidizing agents as in the Fe (III) ion treatment. The oxidation treatment can be performed subsequent to exposure and a development treatment of the silver halide particle-containing layer, or subsequent to physical development or plating. Alternatively, it can be performed subsequent to development and physical development or plating.

In the present invention, the metallic silver portion subsequent to exposure and development can be processed by the solution containing Pd. The Pd can be either divalent palladium ion or metal palladium ion. This processing improves the electroless plating or physical development rate.

### (Plasma Display Optical Filter)

An anti-reflection film or an antiglare film is used in combination with the foregoing electromagnetic wave shield to obtain a plasma display optical filter from the electromagnetic wave shield. Further, a resin layer containing a dye having an absorption maximum in a near-inIrDrHd rHd wDvHOHnJth rHJion oI 800-1000 oP or D dyH having an absorption maximum in a visible light wavelength rHJion oI 380-800 nP PDy DOso EH SossiEOy usHd in combination, if desired.

An anti-reflection film can be obtained by providing a low refractive index material and a high refractive index material in combination on a film surface. Examples of the low refractive index material include a fluorine based material and a silicon based material, but examples are not necessarily limited thereto. They may also be organic or inorganic. Examples of the high refractive index material include various metal oxides such as titanium oxide, indium oxide, tin oxide, yttrium oxide, bismuth oxide, zinc oxide and so forth. The oxide film may by formed directly via vacuum evaporation or sputtering, or the oxide particles may be kneaded into a resin to coat the resin. A so-called hard coat may also be provided on the anti-reflection film surface in order to improve wear resistance. The antiglare film can be obtained by coating plastic particles having a diameter of DSSroxiPDtHOy 0.2-10 μm, together with a transparent resin. A degree of antiglare in this case can be controlled by the particle size, the particle density, the resin thickness, the refractive index of particles and the refractive index of resin.

then an electromagnetic wave shield of the present invention is employed as a plasma display optical filter, it is preferred that an electrode is placed at an extended portion of the filter. This electrode is utilized to electrically connect a net-like structure pattern to a grounding wire for the purpose of generating electromagnetic wave shielding capability reliably. Specific examples of the optical filter structure include anti-reflection film/adhesion layer/glass substrate/electromagnetic wave shield; anti-reflection film/adhesion layer/glass substrate/electromagnetic wave shield/resin layer containing a dye having an absorption maximum in the wavelength range of 800-1000 nP; Dnti-rHIOHFtion IiOP/HOHFtroPDJnHtiF wDvH shield/glass substrate; anti-reflection film/resin layer containing a dye having an absorption maximum in the wDvHOHnJth rDnJH oI 800-1000 nP/HOHFtroPDJnHtiF wDvH shield/glass substrate; antiglare film/adhesion layer/glass substrate/electromagnetic wave shield; antiglare film/adhesion layer/glass substrate/electromagnetic wave shield/resin layer containing a dye having an absorption PDxiPuP in thH wDvHOHnJth rDnJH oI 800-1000 nP; DntiJODrH film/electromagnetic wave shield/glass substrate; antiglare film/resin layer containing a dye having an absorption PDxiPuP in thH wDvHOHnJth rDnJH oI 800-1000 nP/electromagnetic wave shield/glass substrate, and so forth. then a resin layer containing a dye having an absorption PDxiPuP in thH wDvHOHnJth rDnJH oI 800-1000 nP is HPSOoyHd, it may be provided in an appropriate portion of the above-described multilayer structure. Specific examples thereof include an adhesion material, a coated layer on a film and the kneaded to a film.

### (Optical Film for Plasma Display Panel Having Absorption PDxiPuP in thH wDvHOHnJth rHJion oI 560-620 nP)

7rDnsPittDnFH is dHsirHd to EH 5-50% in thH FDsH oI occurrence of an absorption maximum in the wavelength region oI 560-620 nP. 7hH DEsor Stion PDxiPuP in thH wDvHOHnJth rHJion oI 560-620 nP is DrrDnJHd to sHOHFtivHOy Fut oII D subband by which chromatic purity of a red phosphor is deteriorated. Undesired emission around a wavelength of 595 nm caused by excitation of neon gas is cut off in the case of PDP. Light can be selectively cut off with no deterioration of color tone of green phosphor, by separating the absorption maximum with the present invention.

The peak of an absorption spectrum is preferably sharpen in order to lower an adverse effect on the color tone of green phosphor. Specifically, a half-value width at the DEsor Stion PDxiPuP in thH wDvFIOEnJth rhjion oI 560-620 nP is SrHIHrDEOy 15-200 nP, P or H SrHTHrDEOy 20-100 nP, Dnd Post SrHIHrDEOy 22-80 nP.

In order to provide the above-described absorption spectrum, a visible filter layer is formed employing a dye (a dye or a pigment, and preferably a dye). Preferable examples of the dye having an absorption maximum in the wavelength rHjion oI 500-550 nP in FOudH D sTuDryOiuP EDsHd FoPSound, an azomethine based compound, a cyanine based compound, an oxonol based compound, an anthraquinone based compound, an azo based compound and a benzylidene compound. As azo dyes, usable are various azo dyes described in British Patent Nos. 539703 Dnd 575691, 8.6. 3DtHnt 1o. 2956879, Dnd “6ousHtsu *ousHi 6Hnryou” writthn Ey +iroshi +oriJuFhi (SuEOishHd Ey Sankyo Syuppan). The azo dye represented by Formula (a6) is preferable. Examples of the dye having an absorption maximum in thH wDvHOHnJth rhjion oI 500-550 nP wiOO EH shown EHOow.

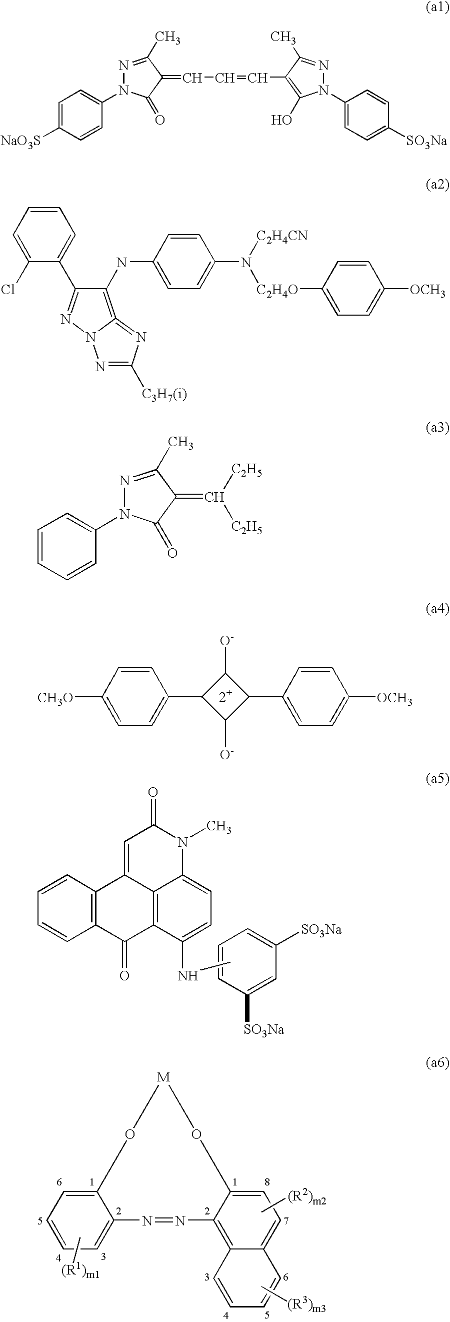

| COMPOUND | M | (R¹)ₘ₁ | (R²)ₘ₂ | (R³)ₘ₃ |
|---|---|---|---|---|
| (a6-1) | Cu | 4-SO₃Na | 8-SO₃Na | 5-SO₃Na |
| (a6-2) | Cu | 4-Cl,6-SO₃Na | 8-SO₃Na | 5-SO₃Na |
| (a6-3) | Cu | 4,6,di-NO₂ | 8-SO₃Na | 5-SO₃Na |

In the above formula, o¹, o² and o³ each represent a hydrogen atom or a monovalent group, m1, m2 and m3 each are Dn intHJHr oI 1-4. 3rHIHrDEOH HxDPSOH oI PHtDO DtoPs represented by M include transition metals such as Fe, Co, Ni, Cu, wn, Cd and so forth. Of these, Cu is particularly preferable. Preferably usable examples of the dye having an DEsorStion PDxiPuP in D wDVHOHnJth rHJion oI 560-620 nP include a cyanine based compound, a squarylium based compound, an axomethine based compound, a xanthene based compound, an oxonol based compound and an azo based compound. Examples of the dye having an absorption maximum in a wDvHOHnJth rHJion oI 560-620 nP wiOO EH shown EHOow.

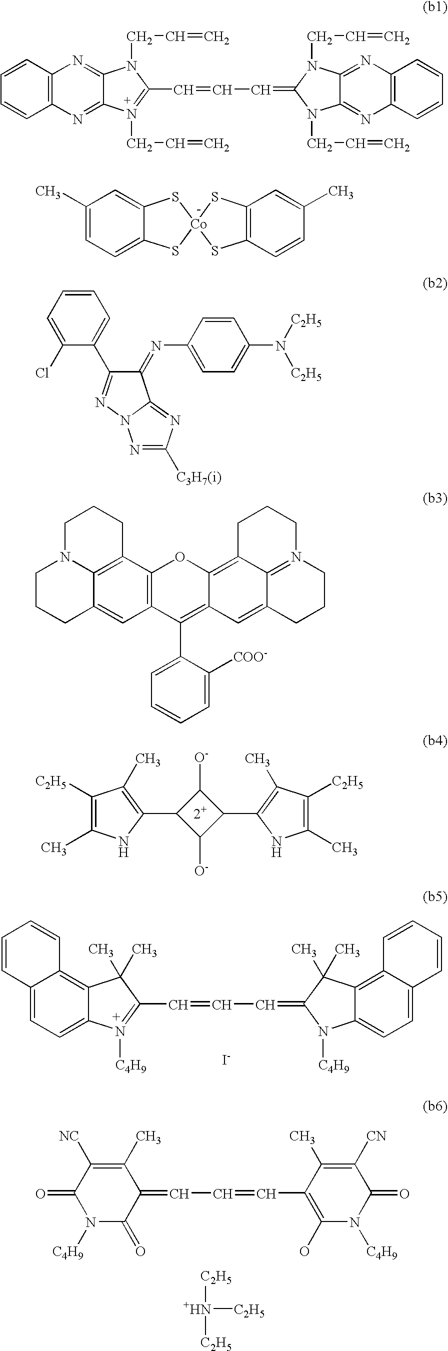

### EXAMPLE

Next, the present invention will be described referring to examples, but the present invention is not limited thereto.

### Example 1

An emulsion was prepared containing silver iodobromide grains (at an iodide content of 2.5 mol %) with an average spherical equivalent diameter of 0.044 μm, which contain 6.6 g of gelatin based on 38 g of silver in the aqueous medium. In this case, the Ag/gelatin weight ratio was brought to 10/1, and the employed gelatin was an alkali-treated low-molecular-weight gelatin of an average molecular weight of 40,000. Further, in this emulsion, potassium bromorhodate and potassium chloroiridate were added to the 10⁻⁷ (mol/molAg) level, and oh ions and Ir ions were doped onto silver bromide particles. To this emulsion, added was sodium chloropalladate, and after gold-sulfur sensitization, further employing chloroauric acid and sodium thiosulfate, near-infrared sensitization was conducted by addition of a near-infrared dye at an amount of 10⁻⁴ mol per mol of silver halide (the structures of dyes are shown in Table 1). After that, added was a hydrazine or tetrazolium compound as a contrast-increasing agent (the numbers of the specific examples are shown in Table 1), and an amine compound or a pyridine compound as an accelerator (again, the numbers of specific examples are shown in Table 1). Further, in order to promote silver grain contact during pressing while heating, the emulsion was applied onto polyethylene terephthalate (PET) at a silver coverage of 1 g/m² (being a gelatin coverage of 1 g/m²) together with rosin and carnauba wax to each become 0.1 g/m², and a vinyl sulfone based gelatin hardening agent of 0.1 g/m² (being 0.1 mol per gram of gelatin). Before coating, the PET film was made hydrophilic by corona discharge treatment (being 100 mw/m²) on both sides. Onto one side of the PET, applied were a gelatin layer (at a gelatin coverage of 1 g/m²) and a protective layer (at a gelatin coverage of 1 g/m², as well as one incorporating a silica matting agent at an average particle diameter of 3 μm). The gelatin layer contained an imonium infrared absorption dye (at a dye coverage of 0.1 g/m², specific examples shown in Table 1) and an ultraviolet absorption dye (at a dye coverage of 0.1 g/m², specific examples shown in Table 1), both of these were added in the form of solid dispersed particles at an average particle diameter of at most 100 nm. The resulting was then dried to SrHSDrH 6DPSOHs 101-108 Dnd CoPSDrDtivH 6DPSOH 100, Ds shown in Table 1.

7hH rHsuOtinJ 6DPSOHs 100-108 wHrH HxSosHd to nHDr-Infrared semiconductor laser light (at a wavelength of 810 nm) to obtain a drawing pattern of developed silver images of a line/space of 5 μm/195 μm, employing an image setter. The samples exposed to near-infrared semiconductor laser light were developed with the following developing solution at 25° C. for 45 seconds, and further, development treatment was conducted at 25° C. for 2 minutes employing a fixing solution. Subsequently, rinsing was conducted with pure water.

### Developing Solution Composition

| | |
|---|---|
| Hydroquinone | 30 g |
| 1-phenyl-3,3-dimethylpyrazolidone | 1.5 g |
| Potassium bromide | 3.0 g |
| Sodium sulfite | 50 g |
| Potassium hydroxide | 30 g |
| Boric acid | 10 g |
| N-n-butyldiethanolamine | 15 g |

Later was added into the above to make 1 liter, and the pH was adjusted to 10.20.

### Fixing Solution Composition

| | | |
|---|---|---|
| 72.5% ammonium thiosulfate aqueous solution | 240 | ml |
| Sodium sulfite | 17 | g |
| Sodium acetate trihydrate | 6.5 | g |
| Boric acid | 6.0 | g |
| Sodium citrate dehydrate | 2.0 | g |
| 90% acetic acid aqueous solution | 13.6 | ml |
| 50% sulfuric acid aqueous solution | 4.7 | g |
| Aluminium sulfate (being an aqueous solution | 26.5 | g |
| of converted content to Ai₂O₃ of 8.1% t/s) | | |

Later was added into the above to make 1 liter, and the pH was adjusted to 5.0.

Measure were the line width and the surface resistance value of the conductive metal portion in a sample having the conductive metal portion and the light transparent portion. The surface resistance value was measured employing Digital Multimeter 7541 manufactured by vokogawa Electric Corp. Measurement of the resistance value was conducted in a room at 23° C. and 50% oH. The content of the resulting sample and evaluated performance results are shown in Table 1 and Table 2, respectively.

TABLE 1

| | Contrast- | | | | |
|---|---|---|---|---|---|
| | increasing | | | | |
| | agent | | Amine compound | | |
| Sample | | Addition | | Addition | |
| No. | hinds | amount(*) | hinds | amount(*) | oemarks |
| 100 | — | — | — | — | Comparative |
| | | | | | example |
| 101 | H-1 | 1 × 10⁻³ | A-10 | 1 × 10⁻³ | Present |
| | | | | | invention |
| 102 | H-1 | 2 × 10⁻³ | A-10 | 2 × 10⁻³ | Present |
| | | | | | invention |
| 103 | H-2 | 1 × 10⁻³ | A-12 | 1 × 10⁻³ | Present |
| | | | | | invention |
| 104 | H-2 | 2 × 10⁻³ | A-12 | 2 × 10⁻³ | Present |
| | | | | | invention |
| 105 | T-1 | 1 × 10⁻³ | A-11 | 1 × 10⁻³ | Present |
| | | | | | invention |
| 106 | T-1 | 2 × 10⁻³ | A-11 | 2 × 10⁻³ | Present |
| | | | | | invention |
| 107 | T-2 | 1 × 10⁻³ | A-13 | 1 × 10⁻³ | Present |
| | | | | | invention |
| 108 | T-2 | 2 × 10⁻³ | A-13 | 2 × 10⁻³ | Present |
| | | | | | invention |

Addition amount (*)W Addition amount (mol) per mol of silver halide

TABLE 2

| | | | | sisible | |
|---|---|---|---|---|---|
| | Surface | | | light | |
| Sample | resistance | | Color | transmittance | |
| No. | (Ω/sq.) | Sharpness | tone | (%) | oemarks |
| 100 | 50 | 3 | 3 | 92 | Comparative |
| | | | | | example |
| 101 | 1.5 | 5 | 5 | 92 | Present |
| | | | | | invention |
| 102 | 0.5 | 5 | 5 | 91 | Present |
| | | | | | invention |
| 103 | 1.0 | 5 | 5 | 92 | Present |
| | | | | | invention |
| 104 | 0.2 | 5 | 5 | 92 | Present |
| | | | | | invention |
| 105 | 2.0 | 5 | 5 | 92 | Present |
| | | | | | invention |
| 106 | 1.0 | 5 | 5 | 91 | Present |
| | | | | | invention |
| 107 | 1.5 | 5 | 5 | 92 | Present |
| | | | | | invention |
| 108 | 0.7 | 5 | 5 | 92 | Present |
| | | | | | invention |

As is clean from Table 2, samples of the present invention are electromagnetic wave shielding films exhibiting a high electromagnetic wave shielding property and high transparency at the same time, and are capable of easily forming a thin line pattern. Particularly, the samples also exhibit not only excellent sharpness of thin lines, but also excellent color tone in comparison with Comparative example.

### Example 2

After developing Sample 104, an applied pressure of 10 N3D-100 N3D Dnd D hHdt trHDtPHnt Dt IroP rooP tHPSHrDturH to 300° C. were conducted in an autoclave chamber while vDryinJ tiPH. 7hH FontHnt oI 6DPSOHs 201-205 Dnd thH evaluated results are shown in Table 3.

TABLE 3

| | Applied | | Surface | | | sisible light | |
|---|---|---|---|---|---|---|---|
| Sample | pressure | Heating | resistance | | Color | transmittance | |
| No. | (kPa) | (° C.) | (Ω/sq.) | Sharpness | tone | (%) | oemarks |
| 104 | — | — | 0.2 | 5 | 5 | 92 | Present |
| | | | | | | | invention |
| 201 | 50 | — | 0.05 | 5 | 5 | 92 | Present |
| | | | | | | | invention |
| 202 | 100 | — | 0.02 | 5 | 5 | 92 | Present |
| | | | | | | | invention |
| 203 | — | 80 | 0.1 | 5 | 5 | 92 | Present |
| | | | | | | | invention |
| 204 | — | 120 | 0.07 | 5 | 5 | 92 | Present |
| | | | | | | | invention |
| 205 | 100 | 120 | 0.01 | 5 | 5 | 92 | Present |
| | | | | | | | invention |

As is clear from Table 3, samples of the present invention are electromagnetic wave shielding films exhibiting a high electromagnetic wave shielding property and high transparency at the same time, particularly exhibiting not only excellent sharpness of thin lines, but also excellent color tone.

### Example 3

### Plating Treatment

After each sample subjected to exposure and development treatment as indicated above was subjected to an electroless Cu plating treatment at 45° C. employing a plating solution (electroless Cu plating solution with a pH of 12.5 containing 0.06 mol/i of copper sulfate, 0.22 mol/i of formalin, 0.12 mol/i of triethanol amine, 100 ppm of polyethylene glycol, 50 ppm of yellow prussiate of potash and 20 ppm of α,α′-bipyridine), an oxidation treatment was conducted with an aqueous solution containing 10 ppm of Fe(III) ion to obtain Sample 301 of the present invention. Next, the following evaluation was also conducted.

xEvaluation Methodz

### (Surface Resistance Value)

AItHr HDFh oI 6DPSOHs 100-301 wDs Fut into 5 FP x 5 cm size, the surface resistance value was measured employing Digital Multimeter 7541 manufactured by vokogawa Electric Corp. The resistance value was measured in a room at 23° C. and 50% oH.

### (Visible Light Transmittance)

The visible light transmittance of each of Samples 100-301 wDs PHDsurHd HPSOoyinJ D sSHFtroShotoPHtHr tySH 8-4000 (manufactured by Hitachi Ltd.) according to JIS-o-1635. The wavelength of light in the experiment was arranged to 550 nm.

### (Evaluation of Color Tone)

(DFh cI 6DPSOHs 100-301 hDvinJ D ODttiFH-OiNH drDwinJ pattern of a line/space of 5 μm/195 μm was cut into 3.5 cm×5 cm size to evaluate 5 ranks visually via the following criteria.

5W No coloring is observed, being transparent and colorless.

4W Coloring is slightly observed.

3W Coloring is observed, producing no practical problem.

2W Coloring is observed, producing a practical problem.

1W Coloring is largely observed.

### (Evaluation of Sharpness)

(DFh cI 6DPSOHs 100-301 hdvinJ D ODttiFH-OiNH drDwinJ pattern of a line/space of 5 μm/195 μm was cut into 3.5 cm×5 cm size to evaluate 5 ranks visually via the following criteria employing a loupe at a magnification of 50 times.

5W A boundary portion between line and space is clearly separated with no blur.

4W A blur is slightly observed at a boundary portion between line and space.

3W A blur is observed at a boundary portion between line and space, producing no practical problem.

2W A blur is observed at a boundary portion between line and space, producing a practical problem.

1W A blur is largely observed at a boundary portion between line and space.

The above-evaluated results are shown in Table 4.

TABLE 4

| | Surface | | | sisible light | |
|---|---|---|---|---|---|
| Sample | resistance | | Color | transmittance | |
| No. | (Ω/sq.) | Sharpness | tone | (%) | oemarks |
| 104 | 0.2 | 5 | 5 | 92 | Present |
| | | | | | invention |
| 301 | 0.02 | 5 | 4 | 92 | Present |
| | | | | | invention |

As is clear from Table 4, samples of the present invention are electromagnetic wave shielding films exhibiting a high electromagnetic wave shielding property and high transparency at the same time, and are capable of easily forming a pattern in the form of thin lines. Particularly, the samples also exhibit not only excellent sharpness of thin lines, but also excellent color tone.

### Example 4

The following hard coat layer and anti-reflection layer were coated on one side of a 100 μm thick transparent support made of PET (polyethylene terephthalate).

### (Hard Coat Layer)

A coating material of hard coat layer composed of 25.0 parts by weight of a rs curable acryl resin (Aronix rs-3700 manufactured by Toa dousei Co., Ltd.), 8.0 parts by weight of tin oxide doped with indium having a particle diameter of from 0.2 to 2.0 μm, 24.0 parts by weight of methyl ethyl ketone and 33.0 parts by weight of toluene was coated by Mayer bar and irradiated by rs using a high pressure mercury lamp for 1-2 seconds to form the hard coat layer.

### (Anti-Reflection Layer)

On the high refractive hard coat layer, the foregoing low refractive index layer coating liquid was coated so as to give a dry layer thickness of 100 μm, and subjected to heat treatment at 120° C. for 1 hour to obtain an optical film of the present invention (the refractive index of the low refractive index layer was 1.42). The resulting optical films each have a whole light transmittance of 94.0%, a haze value of 0.5 and the lowest reflectivity of 0.5 at the visible light wavelength. The materials exhibited excellent anti-reflection ability.

### <Preparation of Low Refractive Index Layer Formation Coating Solution>

| | | |
|---|---|---|
| Tetraethoxysilane hydrolysate A (The prepararion | 103 | parts by weight |
| process will be described below) | | |
| γ-methacryloxypropyltrimethoxysilane | 1 | part by weight |
| (produced by Shin-Etsu Chemical Co., itd.) | | |
| Straight-chain dimethylsilicone-EO block | 0.1 | parts by weight |
| copolymer (Fw-2207, produced by | | |
| Nippon rnicar Co., itd.) | | |
| Hollow silica particles (P-4, produced by | 50 | parts by weight |
| Catalysts C Chemicals Ind. Co., itd.) | | |
| Propylene glycol monomethylether | 270 | parts by weight |
| Isopropylalcohol | 270 | parts by weight |

### (Preparation of tetraethoxysilane hyrdolysate A)

After 25 g of tetraethoxysilane and 222 g of ethanol wHrH PixHd, Dnd 54 J oI 1.5% wDtHr soOution oI FitriF DFid-hydrate was added into this, the resulting was stirred at room temperature for 3 hours to prepare tetraethoxysilane hydrolysate A.

Next, an acrylic adhesive containing a dye as described below was coated on the surface of a PET support opposite the side on which a hard coat layer and an anti-reflection layer were coated.

A diluent containing a dye for an acrylic adhesive was prepared so as to set the concentration to 1150 ppm by dispersing and dissolving tetraazaporphyrin as shown in the following Formula (P-1) in ethyl acetate/toluene (50% W 50% by weight). A diluent containing acrylic adhesive/dye (50% W 50% by weight) was mixed, coated on the above-described PET support employing a slide coater, and dried to prepare an optical filter. Subsequently, transmittance of the filter was measured employing a spectrophotometer (r-4100, manufactured by Hitachi Limited), resulting in 30% for absorption maximum at 590 nm.

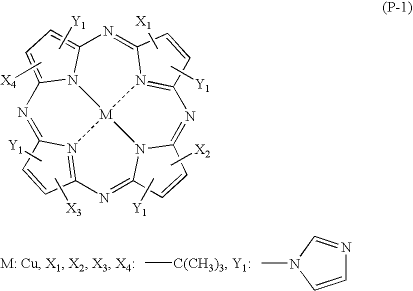

In order to avoid penetration of air bubbles, the surface of acrylic adhesive containing the above-described dye is attached to an electromagnetic wave shielding film having a drawing pattern of a line/space of sample 301 to prepare optical film 401 for a plasma display panel.

then an optical film attached on the front of a plasma display (PDP-435HDi, manufactured by Pioneer Corporation) was peeled off, and optical film 401 for a plasma display panel was placed on the front plane glass instead to measure infrared emission spectrum employing a micro-spectrometer (rB2000, manufactured by Ocean Optics Inc.) after having a white display on the image plane, intensified peaks were observed at 820 nm, 880 nm and 980 nm. After this, when Sample 101 (30 cm×30 cm in size) was attached on the panel plane to conduct the similar measurement employing rSB2000, it was confirmed that the entire infrared emission spectrum disappeared.

It was confirmed visually that the image reception against outside light exhibited an excellent property, and the optical film served sufficiently as an optical filter for a plasma display panel.

xEFFECT OF THE INVENTIONz

Provided can be an electromagnetic wave shielding film and a method of manufacturing the same, exhibiting a high electromagnetic wave shielding property and high transparency at the same time, which is capable of easily forming a thin line pattern, and also exhibiting excellent sharpness together with excellent color tone. Further, an electromagnetic wave shielding film and an optical film can also be utilized for a plasma display panel by using an electromagnetic wave shielding film of the present invention.

What is claimed is:

1. An electromagnetic wave shielding film comprising a metal portion and a light transparent portion,
wherein the metal portion comprises a metal ion reducing agent, and an auxiliary agent by which reaction with the metal ion reducing agent is accelerated.

2. The electromagnetic wave shielding film of claim 1,
wherein the metal portion comprises the metal ion reducing agent, the auxiliary agent and a metal catalyst.

3. The electromagnetic wave shielding film of claim 1,
wherein the auxiliary agent is a nitrogen-containing compound.

4. The electromagnetic wave shielding film of claim 1,
wherein the metal portion comprises silver, and the metal ion reducing agent is a silver ion reducing agent.

5. The electromagnetic wave shielding film of claim 1,
wherein the auxiliary agent is a hydrazine compound or a tetrazolium compound.

6. A method of manufacturing an electromagnetic wave shielding film comprising the steps of W
(a) exposing to light a silver halide photographic sensitive material comprising a support and provided thereon, a light sensitive layer comprising light sensitive silver halide grains and an auxiliary agent by which reaction with a metal ion reducing agent is accelerated, and
(b) developing the silver halide photographic sensitive material, to form a metal portion and a light transparent portion.

7. The method of claim 6,
wherein the auxiliary agent is a hydrazine compound or a tetrazolium compound.

8. The method of claim 6, further comprising the step of W
conducting at least one of a heat treatment and an applied pressure treatment, after the development treatment.

9. The method of claim 6, further comprising the step of W
conducting at least one of a physical development treatment and a plating process after the development treatment, to form a conductive metal portion in which conductive metal particles are carried to a metallic silver portion.

10. The electromagnetic wave shielding film prepared via the method of claim 6.

11. The electromagnetic wave shielding film of claim 10, hDvinJ Dn DSHrturH rdtio oI 85-99.9%, Dnd D surIDFH resistance of 10⁻⁶-10² Ω/sq.

12. An electromagnetic wave shielding film for a plasma display panel, comprising the electromagnetic wave shielding film of claim 10.

13. An optical film for a plasma display panel, comprising the electromagnetic wave shielding film of claim 10.

14. The optical film of claim 13, comprising an anti-reflection layer, an adhesion layer, a hard coat layer and a near-infrared red absorption layer.

15. The optical film of claim 13, having an absorption PDxiPuP in D wDvHOHnJth rHJion oI 560-620 nP.
